(19) United States
(12) Patent Application Publication
(10) Pub. No.: US 2016/0049695 A1
(43) Pub. Date: Feb. 18, 2016

(54) BATTERY MODULE

(71) Applicants: Hyundai Motor Company, Seoul (KR); Kia Motors Corporation, Seoul (KR)

(72) Inventors: Hae Kyu Lim, Bucheon (KR); Yoon Cheol Jeon, Suwon (KR)

(21) Appl. No.: 14/552,922

(22) Filed: Nov. 25, 2014

(30) Foreign Application Priority Data
Aug. 12, 2014 (KR) 10-2014-0104329

(51) Int. Cl. H01M 10/42; H01M 10/48

(52) U.S. Cl. CPC H01M 10/4257; H01M 10/48; H01M 2200/00

(57) ABSTRACT

A battery module capable is provided in which a fuse is replaced to improve safety. The battery module includes a battery housing and a voltage sensing part disposed within the housing and configured to sense a voltage within the housing. In addition, a fuse box part is configured to be electrically connected to the voltage sensing part and have a fuse provided therein.

### CROSS-REFERENCE TO RELATED APPLICATION

This application is based on and claims the benefit of priority to Korean Patent Application No. 10-2014-0104329, filed on Aug. 12, 2014 in the Korean Intellectual Property Office, the disclosure of which is incorporated herein in its entirety by reference.

### TECHNICAL FIELD

The present disclosure relates to a battery module, and more particularly, to a battery module capable of replacing a fuse for safety improvement.

### BACKGROUND

Recently, an eco-friendly electric vehicle which may reduce energy consumption and environmental pollution has been variously developed. An example may include a fuel cell vehicle and a hybrid vehicle. The fuel cell vehicle is a vehicle which uses electricity generated by an electrochemical reaction of hydrogen and oxygen as an energy source. The hybrid vehicle is a vehicle which uses an internal combustion engine while driven at a substantially high speed or driven on an uphill road and uses electricity as the energy source is driven at a substantially low speed or while being parked.

The fuel cell vehicle and the hybrid vehicle (hereinafter, collectively referred to as “electric vehicle”) have a battery pack for supplying electricity. A battery pack as known in the related art uses a surface mount device (hereinafter, collectively referred to as “SMD”) type fuse for securing safety against ignition due to damage of a voltage sensor and a short caused by a hardware failure, a control error, internal and external factors such as impact/collision, and the like.

However, since a voltage sensing PCB substrate, a fuse, a bus bar, a connector, and the like which are components for voltage sensing of a cell within the battery pack are integrally configured by soldering and a cell tab and a voltage sensing bus bar are welded to each other, when the fuse is damaged due to abnormal external factors such as short, only the fuse may not be replaced and thus a unreasonable problem of replacing the battery pack may occur. To replace only the fuse, a blade type fuse may be used. However, in the blade type fuse a size of a battery package is increased, man hour is increased, costs are increased, and mass production deteriorates.

### SUMMARY

The present disclosure provides a battery module capable of replacing only a fuse by applying a SMD type fuse.

According to an exemplary embodiment of the present disclosure, a battery module may include: a battery housing; a voltage sensing part configured to be disposed within the housing to sense a voltage within the housing; and a fuse box part configured to be electrically connected to the voltage sensing part and have a fuse provided therein. The housing may include: an electrode assembly; an upper assembling part configured to be coupled with an upper portion of the electrode assembly; and a lower assembling part configured to be coupled with a lower portion of the electrode assembly.

The voltage sensing part may include: a pair of bus bar assemblies configured to be disposed on a side of the lower assembling part to be electrically coupled with the fuse box part; and a connection wire configured to electrically connect the pair of bus bar assemblies to each other. The pair of bus bar assemblies may further include bus bars of a wire pressing type. The fuse box part may be molded with a PCB assembly in which a plurality of fuses are mounted. The fuse box part may be detachably coupled with the voltage sensing part.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary view schematically illustrating a battery module according to an exemplary embodiment of the present disclosure;

FIG. 2 is an exemplary diagram illustrating that a fuse box part of FIG. 1 is separated according to an exemplary embodiment of the present disclosure;

FIG. 3 is an exemplary diagram illustrating only a lower assembling part and the fuse box part of FIG. 2 according to an exemplary embodiment of the present disclosure;

FIG. 4 is an exemplary diagram illustrating only a voltage sensing part and the fuse box part of FIG. 3 according to an exemplary embodiment of the present disclosure; and

FIG. 5 is an exemplary configuration diagram schematically illustrating that the voltage sensing part and the fuse box part according to the exemplary embodiment of the present disclosure are electrically connected to each other.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, exemplary embodiments of the present disclosure will be described in detail with reference to the accompanying drawings. However, the present disclosure will be not limited or restricted to the exemplary embodiments below. Like reference numerals proposed in each drawing denote like components.

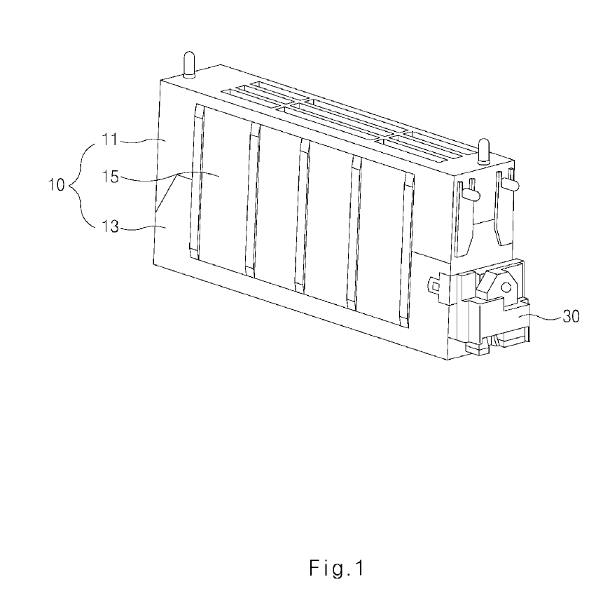

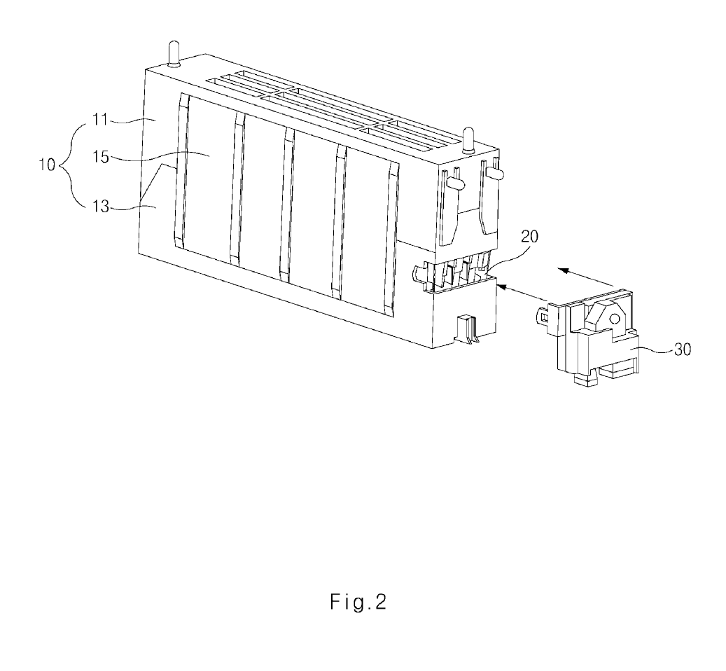

FIG. 1 is an exemplary view schematically illustrating a battery module according to an exemplary embodiment of the present disclosure and FIG. 2 is an exemplary diagram illustrating that a fuse box part of FIG. 1 is separated. As illustrated in FIGS. 1 and 2, the battery module according to the exemplary embodiment of the present disclosure may include a battery housing 10, a voltage sensing part 20 configured to be disposed within the housing 10 and configured to sense a voltage within the housing 10, and a fuse box part 30 configured to be electrically connected to the voltage sensing part 20 and have a fuse provided therein.

The housing 10 may include an electrode assembly (not illustrated) disposed therein, an upper assembling part 11 coupled with an upper portion of the electrode assembly, and a lower assembling part 13 coupled with a lower portion of the electrode assembly. The upper assembling part 11 and the lower assembling part 13 may be coupled with each other to fix the electrode assembly while protecting the electrode assembly from external environment, impact, and the like. Further, an outer surface of the electrode assembly disposed between the upper assembly part 11 and the lower assembly part 13 may include a cover member 15 to protect the electrode assembly.

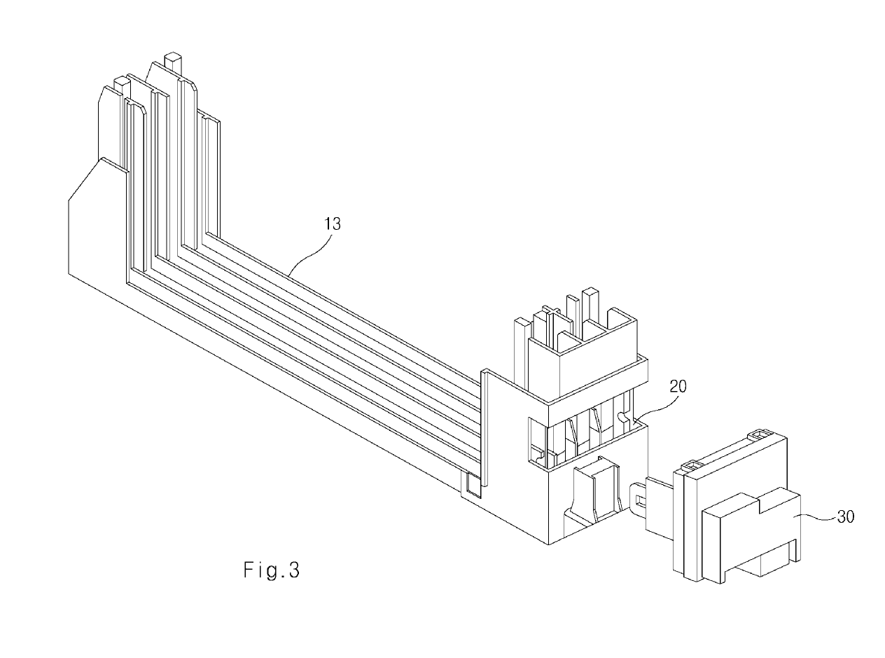

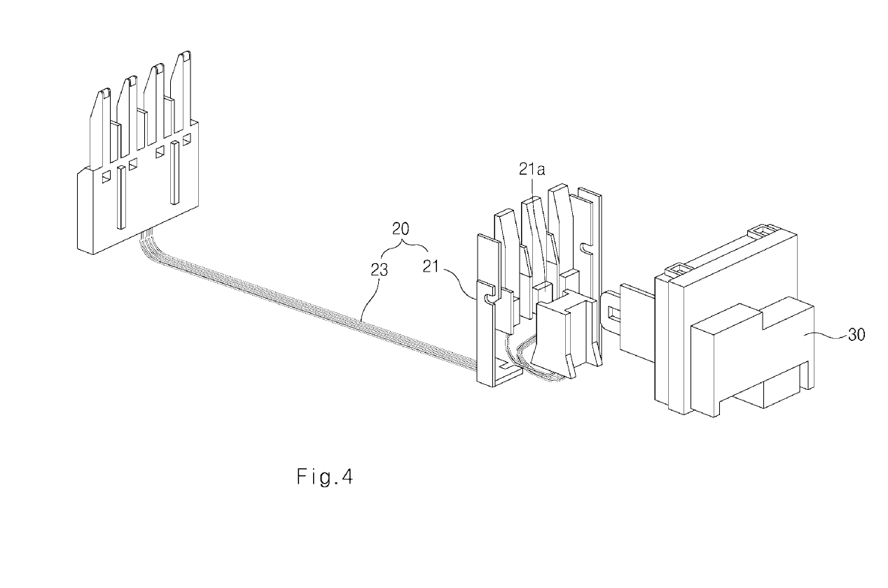

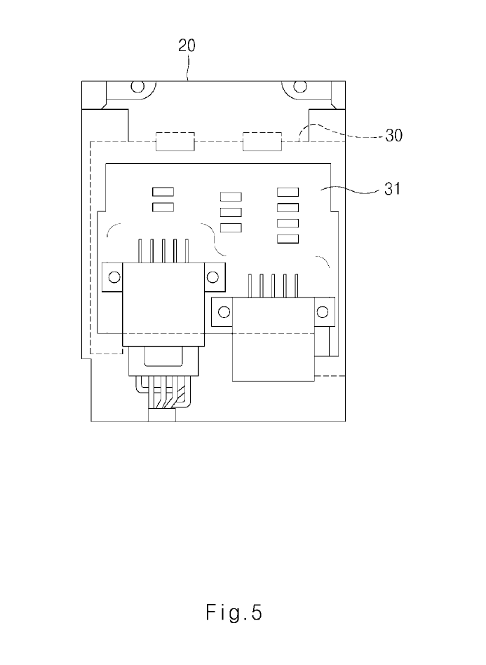

FIG. 3 is an exemplary diagram illustrating a lower assembling part and the fuse box part of FIG. 2, FIG. 4 is an exemplary diagram illustrating a voltage sensing part and the fuse box part of FIG. 3, and FIG. 5 is an exemplary configuration diagram schematically illustrating that the voltage sensing part and the fuse box part according to the exemplary embodiment of the present disclosure are electrically connected to each other.

As illustrated in FIGS. 2 to 5, the voltage sensing part 20 may be disposed on one side or both sides of the lower assembling part 13 to expose a portion of the voltage sensing part 20 to the exterior and may include a pair of bus bar assemblies 21 electrically coupled with the fuse box part 30 and a connection wire 23 by which the pair of bus bar assemblies 21 may be electrically connected to each other. In particular, the pair of bus bar assemblies 21 may include a plurality of bus bars 21a of a wire pressing type to be electrically connected to the fuse box part 30 coupled with the voltage sensing part 20. Meanwhile, an arrow in FIG. 2 illustrates an assembling direction of the fuse box part 30 and the fuse box part 30 may be detachably coupled with the lower assembling part 13 by a hook, and the like.

Referring to FIG. 5, the fuse box part 30 may be molded with a PCB assembly 31 to provide a PCB assembly 31 mounted with a plurality of fuses (not illustrated). In addition, in FIG. 5, an exterior of the fuse box part 30 is marked by a dotted line and is configured so that the PCB assembly 31 inside the fuse box part 30 is seen. The plurality of fuses may be mounted on a surface electrically connected to the voltage sensing part 20 in the fuse box part 30.

As described above, according to the battery module according to the exemplary embodiments of the present disclosure having the above configuration, it may be possible to reduce costs by replacing only the fuse box without replacing the battery pack at the time of the damage of the fuse by applying the separate fuse box. Furthermore, it may be possible to reduce the repair time improve the safety of the battery system.

Although the battery module according to the exemplary embodiment of the present disclosure has been described with reference to the accompanying drawings, the present disclosure is not limited to the above-mentioned exemplary embodiment and drawings but may be variously modified and changed within the following claims by those skilled in the art to which the present disclosure pertains.

What is claimed is:

1. A battery module, comprising:
a battery housing;
a voltage sensing part disposed within the housing and configured to sense a voltage within the housing; and
a fuse box part configured to be electrically connected to the voltage sensing part and have a fuse provided therein.

2. The battery module according to claim 1, wherein the housing includes:
an electrode assembly;
an upper assembling part configured to be coupled with an upper portion of the electrode assembly; and
a lower assembling part configured to be coupled with a lower portion of the electrode assembly.

3. The battery module according to claim 2, wherein the voltage sensing part includes:
a pair of bus bar assemblies configured to be disposed on a side of the lower assembling part to be electrically coupled with the fuse box part; and
a connection wire configured to electrically connect the pair of bus bar assemblies to each other.

4. The battery module according to claim 3, wherein the pair of bus bar assemblies further include bus bars of a wire pressing type.

5. The battery module according to claim 1, wherein the fuse box part is molded with a PCB assembly in which a plurality of fuses are mounted.

6. The battery module according to claim 1, wherein the fuse box part is detachably coupled with the voltage sensing part.
